(19) United States
(12) Patent Application Publication
(10) Pub. No.: US 2009/0041893 A1
(43) Pub. Date: Feb. 12, 2009

(54) Coffee substitute and method of manufacture

(76) Inventor: Richard J. Vanderhoven, Henderson, NV (US)

Correspondence Address: Richard J. Vanderhoven, 1009 Silver Retreat Ct., Henderson, NV, 89002, US

(21) Appl. No.: 11/891,191

(22) Filed: Aug. 8, 2007

(51) Int. Cl. A23F 5/44; A23F 5/04; A23G 1/00

(52) U.S. Cl. 426/45; 426/466; 426/593

(57) ABSTRACT

A coffee-like beverage is disclosed which is produced solely with cacao or cocoa beans. The product is produced by roasting the cacao beans, then grinding them into a granulated cacao substrate or dry granular coffee-like brewable product, and then brewing that granulated cacao substrate or coffee-like product into a beverage that is richly unique in flavor. A number of preferred methods for producing such a coffee-like drink and the brewable coffee-like product are also disclosed. One such method provides for the incorporation of an additional portion of husk material to enhance the product.

The present invention relates to a coffee-like drink or coffee substitute, and more particularly to a beverage that is produced with the Cacao (Cocoa) bean, which provides a healthier alternative to coffee.

### BACKGROUND OF THE INVENTION

Over the course of many decades the world and the U.S. has become a major consumer of coffee. The main reason for the consumption of coffee is to give the individual a rush, or energy boost which is due to the caffeine content of coffee. Over the years there has been much advancement in the field of dietary science that has raised concerns over the usage of caffeine. Caffeine is by nature a vassal constrictor. That means that the effects of caffeine usage results in decreased blood flow in the body. Caffeine also can raise an individual's blood pressure. Caffeine is also highly addictive, and is habit forming. Prolonged intake of caffeine can result in serious health risks.

To overcome these health risks, a substitute beverage is needed which provides the consumer with a similar taste, aroma and stimulation without the harmful effects of caffeine.

Some coffee drinkers turn to a decaffeinated coffee to avoid the harmful effects of caffeine and in some cases even the excessive stimulation provided by the high levels of caffeine found in standard coffee. However, since the above mentioned stimulation effect derived from the consumption of such levels of caffeine found in a standard coffee is important to many coffee consumers, there must be a stimulant of some type in a commercially successful alternative drink in order to give the consumer the desired energy boost.

Another of the key components that contributes to the coffee drinking pleasure is the aroma. There are few if any coffee substitutes that have a similarly appealing aroma. Such a similar aroma would be conducive to the commercial success of a coffee substitute.

Even more importantly that aroma, a similar tasting product to coffee is an issue that has been a difficult for other coffee substitutes to attain. Many coffee drinkers pride themselves as connoisseurs of the rich taste of coffee. In order to truly be successful in obtaining a significant market share among the many currently available coffee substitutes, an alternative having a similar taste is needed.

### SUMMARY OF THE INVENTION

The present invention is directed to a coffee-like drink including the roasted granular brewable coffee-like dry product and the method of their manufacture. The invention provides to the consumer a stimulant called Theobromine. Theobromine is known to provide milder stimulation, but with a longer lasting effect than that of caffeine. But possibly more importantly, and in contrast to caffeine, Theobromine is a vassal dilator. This means that an individual that ingests Theobromine would have more blood flow throughout the body. This effect has been confirmed in recent studies of Theobromine which have shown that it has an effect on the body of lowering blood pressure. Additionally, the husks of the Cacao bean have been shown to possibly contain other anti-carcinogenic properties.

Additionally the incident inventive coffee-like drink has a remarkably appealing aroma in not only the brewing stage of the process to make the drink, but also in the roasting stage of this process as well.

And more importantly this product, unlike many other substitute coffee products, is remarkably similar in taste to coffee. In fact it has been described by many in taste tests as more flavorful, or more robust in taste, and is also much healthier for anyone who drinks it.

### BRIEF DESCRIPTION OF THE DRAWINGS

FIG. 1 is a flow chart illustrating the preferred method of manufacture of the inventive coffee-like product.

### DETAILED DESCRIPTION OF THE PREFERRED EMBODIMENTS

Surprisingly whole cacao beans are the prime ingredient for this product. Historically, cacao beans have been used for centuries for the source of cocoa liquor and powder from which a well known chocolate drink has been manufactured. However, the distinctive chocolate taste of that drink is achieved by processing cacao beans from which the husks have been removed into a cocoa liquor composed of the fats (cocoa butter) and other bean solids (cocoa powder). Multiple additional steps and additives are required in that known process in order to obtain the familiar cocoa drink, cocoa baking powder, or chocolate.

The raw cacao beans used in this unique process are extracted from pods from the cacao tree as a composition of moist pulp material and raw whole beans. This composition is then typically covered and allowed to ferment to reduce the bitterness of the bean. This fermentation process can be eliminated by separating the whole beans from the pulp immediately and proceeding directly to the drying process. The typical sun drying of either fermented or unfermented whole cacao beans usually takes a few days and is required to lower the moisture content of the whole raw cacao beans to a level sufficient to prevent mold or spoilage during subsequent storage and/or shipment. Dried raw cacao beans can be easily obtained in either a fermented or unfermented state. The preferred embodiment of this invention utilizes fermented dried whole cacao beans, however if a more bitter taste is desired unfermented dried raw cacao beans can be used. Even though the beans are preferably fermented they will still be considered herein as being raw, and will be referred to as such.

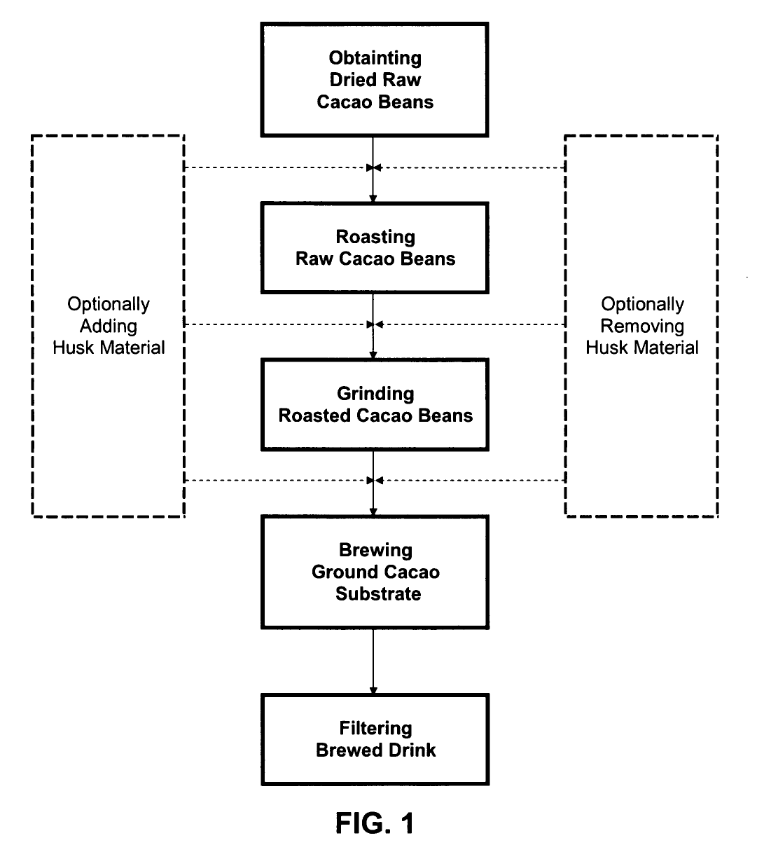

As shown in FIG. 1 these dried raw cacao beans are now roasted until a desired degree of roasting has been accomplished. This is done in much the same way as regular coffee beans with the use of coffee bean roasters. The preferred roasting times for the best results of this process seem to be relatively close to those used to roast Arabica coffee beans. However, unlike the coffee bean roasting process, the inventive whole cacao bean process in preferably done with unshelled cacao beans. This means the husks are included in the roasting process and indeed lend themselves to the production of some of the desirable features of the inventive coffee-like drink. Not the least of which are other potential health benefits as described earlier.

Since the amount of husk material has a significant effect on the coffee-like features of aroma and taste and even possible health benefits, the inventive process optionally allows some control of these features by either adding or removing significant amounts or portions of husk material at any of a number of steps in the process as shown in FIG. 1. Obviously, the stage of the process at which this additional husk material is added determines which processing would have to have been done previously to the husk material before its inclusion. For example, in one embodiment of the inventive process, the additional portion of husk material added to the whole roasted cacao beans prior to grinding also would have been previously roasted. Like wise, un-roasted husks could optionally be added prior to the step of roasting, and ground roasted husk material could optionally be added after the roasted whole beans are ground. Since the standard prior art process for manufacturing cocoa powder requires the removal of essentially all the husks from the cacao beans after roasting, they then become a by product of that process, and are available for purchase at a relatively low cost. Therefore, another optional benefit of including additional husk material in the incident inventive coffee-like product process is an overall reduction in material cost.

After cooling, the roasted cacao beans are then ground into a brewable granulated cacao substrate. Preferably this granulated cacao substrate includes the husk material from the dried whole cacao beans. The presents of a significant portion of the cacao bean husks during this grinding process help to prevent the unwanted development or separation of cacao fats or liquors resulting in a paste-like substance as is an intermediate step in the prior art cocoa powder manufacturing process. Instead the roasted cacao beans including husks and optionally additional portion of roasted husk material is ground by similar means as used to grind coffee beans and with a much the same desired consistency of the resultant brewable coffee-like dry product. The preferred method of grinding utilizes a means which avoids the creation of excess heat that could cause this unwanted cocoa butter separation. One method which is effective in producing a desirable dry granular cacao substrate is a high speed impact type pulverizing grinder. However, many typical grinding means as known in the coffee industry are also effective in obtaining an adequate dry substrate. When grinding the Cacao beans, it is important to note that different levels of granulation can be used to prepare the bean to be brewed as required by various different coffee brewing methods.

Brewing the granulated cacao substrate or product can be accomplished in many different manors to create the inventive coffee-like drink or coffee substitute. Standard drip or auto-drip coffee makers can be used to brew the beverage. As well, percolators and espresso machines are perfectly acceptable means of brewing this beverage. As this product is an alternative to coffee, it is also an alternative to all of the coffee variations, such as espresso, and all of the different forms that a coffee like substance can be brewed into. Also, and for obvious reasons, any known method for pre or post processing coffee drinks or products such as freeze drying or other means of delivery and or packaging are like wise applicable to this coffee-like product or drink.

At this point, the coffee-like drink made from whole cacao beans can now be consumed as is or mixed with a variety of different sweeteners and creamer type substances, to enhance the flavor of the product toward individual tastes.

What is claimed is:

1. A method for preparing a coffee-like drink comprising the steps of:
providing a quantity of dried raw cacao beans;
roasting said quantity of dried raw cacao beans;
grinding said quantity of roasted cacao beans to produce a granulated cacao substrate; and
passing a quantity of hot water through said granulated cacao substrate and a filter medium to obtain said coffee-like drink.

2. The method of claim 1 wherein said quantity of dried raw cacao beans were fermented prior to drying.

3. The method of claim 2 wherein the husks are included in said quantity of roasted cacao beans for the step of grinding.

4. The method of claim 3 wherein said step of passing said quantity of hot water through said granulated cacao substrate and a filter medium to obtain said coffee-like drink is comprised of a brewing method selected from a group consisting of a standard drip method, an auto-drip method, a percolation method, and an espresso machine method.

5. The method of claim 1 wherein the husks are included in said quantity of roasted cacao beans for the step of grinding.

6. The method of claim 5 wherein said step of passing said quantity of hot water through said granulated cacao substrate and a filter medium to obtain said coffee-like drink is comprised of a brewing method selected from a group consisting of a standard drip method, an auto-drip method, a percolation method, and an espresso machine method.

7. The method of claim 1 wherein said step of passing said quantity of hot water through said granulated cacao substrate and a filter medium to obtain said coffee-like drink is comprised of a brewing method selected from a group consisting of a standard drip method, an auto-drip method, a percolation method, and an espresso machine method.

8. A coffee-like drink made by the process of brewing a granulated cacao substrate wherein:
said granulated cacao substrate is made by grinding a quantity of roasted cacao beans; and
said process of brewing is selected from a group consisting of a standard drip process, an auto-drip process, a percolation process, and an espresso machine process.

9. The coffee-like drink of claim 8 wherein a quantity of dried raw cacao beans were fermented prior to the drying and the roasting of said quantity of dried raw cacao beans to produce said quantity of roasted cacao beans.

10. The coffee-like drink of claim 9 wherein a substantial portion of husk material is included when grinding said quantity of roasted cacao beans.

11. The coffee-like drink of claim 9 wherein a substantial portion of husk material is included in said granulated cacao substrate for said process of brewing.

12. The coffee-like drink of claim 8 wherein the husks are included in said quantity of roasted cacao beans when said granulated cacao substrate is made by grinding.

13. The coffee-like drink of claim 8 wherein a substantial portion of husk material is removed from said quantity of roasted cacao beans before said granulated cacao substrate is made by grinding.

14. The coffee-like drink of claim 8 wherein an additional portion of roasted husk material is included in said quantity of roasted cacao beans when said granulated cacao substrate is made by grinding.

15. The coffee-like drink of claim 8 wherein an additional portion of roasted and ground husk material is included in said granulated cacao substrate for said process of brewing.

16. A brewable coffee-like product which is made by grinding a quantity of roasted cacao beans.

17. The brewable coffee-like product of claim 16 wherein said quantity of roasted cacao beans is made by roasting fermented and dried raw cacao beans including a substantial portion of husk material.

18. The brewable coffee-like product of claim 16 wherein said quantity of roasted cacao beans is made by roasting un-fermented and dried raw cacao beans including a substantial portion of husk material.

19. The brewable coffee-like product of claim 16 wherein said quantity of roasted cacao beans is made by roasting fermented and dried raw cacao beans including an additional portion of husk material.

20. The brewable coffee-like product of claim 16 wherein said quantity of roasted cacao beans is made by roasting un-fermented and dried raw cacao beans including an additional portion of husk material.
